(19) United States
(12) Patent Application Publication
(10) Pub. No.: US 2014/0020557 A1
(43) Pub. Date: Jan. 23, 2014

(54) METHODS AND APPARATUSES FOR GENERATING NITROGEN

(71) Applicants: Lubo Zhou, Inverness, IL (US); Chunqing Liu, Arlington Heights, IL (US); Mark E. Schott, Palatine, IL (US); David W. Greer, Cary, IL (US)

(72) Inventors: Lubo Zhou, Inverness, IL (US); Chunqing Liu, Arlington Heights, IL (US); Mark E. Schott, Palatine, IL (US); David W. Greer, Cary, IL (US)

(73) Assignee: UOP LLC, Des Plaines, IL (US)

(21) Appl. No.: 13/554,671

(22) Filed: Jul. 20, 2012

(51) Int. Cl. B01D 53/22

(52) U.S. Cl. 95/51; 96/4

(57) ABSTRACT

Embodiments of methods and apparatuses for generating nitrogen are provided. In one example, a method comprises the steps of contacting at least a portion of a flue gas stream with a CO₂/N₂ separation membrane at conditions effective to form a N₂-rich retentate stream and a CO₂-rich permeate stream. Liquid hydrocarbons are covered with the N₂-rich retentate stream to form a blanket of nitrogen.

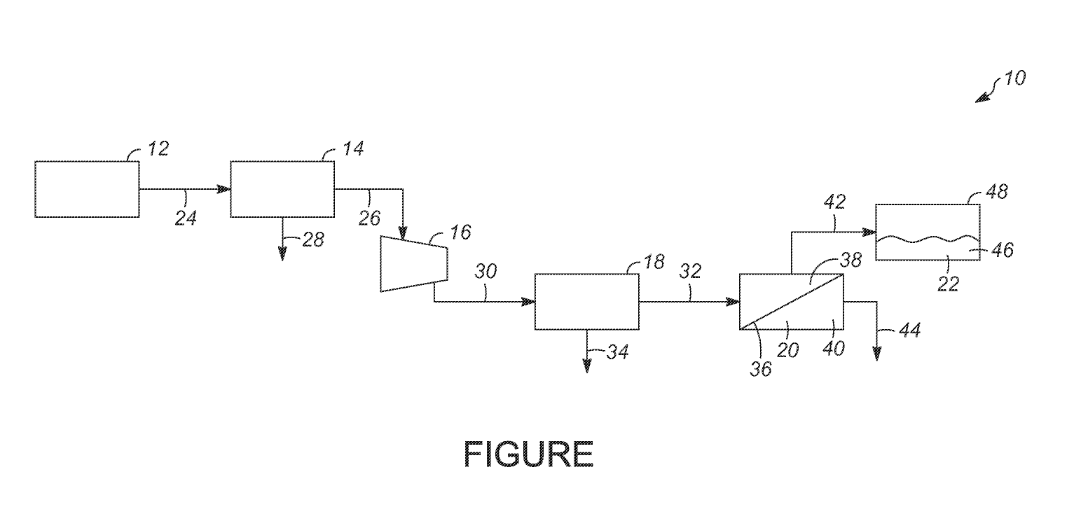

### TECHNICAL FIELD

The present invention relates generally to methods and apparatuses for generating nitrogen, and more particularly relates to methods and apparatuses for generating nitrogen from flue gas using a separation membrane.

### BACKGROUND

In offshore operations, such as floating production storage and offloading (FPSO) and floating liquefied natural gas (FLNG), a floating vessel receives liquid hydrocarbons, e.g., oil or liquefied natural gas, produced from nearby platforms or subsea templates, and processes and stores the liquid hydrocarbons until it can be offloaded onto a tanker or transported otherwise. For safety reasons, a layer of nitrogen is often blanketed over the liquid hydrocarbons during storage on the floating vessel. Because offshore transporting of nitrogen to the floating vessel is impractical and/or prohibitively expensive, nitrogen is typically generated onboard the floating vessel for blanketing the liquid hydrocarbons.

One conventional process for generating nitrogen, such as for offshore operations, uses air and an O₂/N₂ separation membrane. Air, which is about 78% by volume of nitrogen, about 21% by volume of oxygen, and about 1% by volume of other gases, is passed through a compressor to form a compressed air stream. The compressed air stream is directed to the O₂/N₂ separation membrane. The O₂/N₂ separation membrane is a semi-permeable membrane that allows oxygen to preferentially permeate through the membrane over nitrogen. Typically, O₂/N₂ separation membranes have a relatively low selectivity of about 3 to about 5 of oxygen over nitrogen. The retentate gases, e.g., the gases that do not permeate through the membrane, form a N₂-rich stream, e.g., about 95% by volume of nitrogen. Because of the relatively low selectivity of O₂/N₂ separation membranes and the relatively large volume of oxygen and other gases that need to be separated from nitrogen in air, large volumes of air often need to be compressed to meet the ongoing demands for nitrogen for many offshore operations and the like. As such, the capital expenses for larger compressors and/or the associated operational costs for generating nitrogen can be relatively high.

Accordingly, it is desirable to provide methods and apparatuses for generating nitrogen, such as for offshore operations and the like, with reduced capital expenses and/or operating cost. Furthermore, other desirable features and characteristics of the present invention will become apparent from the subsequent detailed description and the appended claims, taken in conjunction with the accompanying drawings and this background.

### BRIEF SUMMARY

Methods and apparatuses for generating nitrogen are provided herein. In accordance with an exemplary embodiment, a method for generating nitrogen comprises the steps of contacting at least a portion of a flue gas stream with a CO₂/N₂ separation membrane at conditions effective to form a N₂-rich retentate stream and a CO₂-rich permeate stream. Liquid hydrocarbons are covered with the N₂-rich retentate stream to form a blanket of nitrogen.

In accordance with another exemplary embodiment, a method for generating nitrogen is provided. The method comprises the steps of removing water from a flue gas stream to form a partially water-depleted flue gas stream. The partially water-depleted flue gas stream is compressed to form a compressed flue gas stream. Water is removed from the compressed flue gas stream to form a compressed water-depleted flue gas stream. The compressed water-depleted flue gas stream is contacted with a CO₂/N₂ separation membrane to form a N₂-rich retentate stream and a CO₂-rich permeate stream.

In accordance with another exemplary embodiment, an apparatus for generating nitrogen is provided. The apparatus comprises a flue gas source that is configured to combust hydrocarbons in the presence of oxygen to form a flue gas stream. A membrane-separation zone comprises a CO₂/N₂ separation membrane and is configured to receive at least a portion of the flue gas stream and to contact the at least the portion of the flue gas stream with the CO₂/N₂ separation membrane at conditions effective to form a N₂-rich retentate stream and a CO₂-rich permeate stream. A liquid hydrocarbon storage zone contains liquid hydrocarbons. The liquid hydrocarbon storage zone is configured to receive the N₂-rich retentate stream and to cover the liquid hydrocarbons with the N₂-rich retentate stream to form a blanket of nitrogen.

### BRIEF DESCRIPTION OF THE DRAWINGS

The present invention will hereinafter be described in conjunction with the following drawing figures, wherein like numerals denote like elements, and wherein:

The Figure schematically illustrates an apparatus and a method for generating nitrogen in accordance with an exemplary embodiment.

### DETAILED DESCRIPTION

The following Detailed Description is merely exemplary in nature and is not intended to limit the invention or the application and uses of the invention. Furthermore, there is no intention to be bound by any theory presented in the preceding background or the following detailed description.

Methods and apparatuses for generating nitrogen are provided herein. Unlike the prior art, the embodiments taught herein contact at least a portion of a flue gas stream with a CO₂/N₂ separation membrane. The flue gas is formed from a flue gas source, such as from a utility section of an offshore operation that combusts hydrocarbons in the presence of oxygen, e.g., air, to produce electricity, heat and/or steam, and the like for the offshore operation. Typically, the flue gas comprises about 75 to about 80% by volume of nitrogen, about 7 to about 8% by volume of carbon dioxide, about 15% or greater by volume of water, and a remainder of other gases including oxygen, carbon monoxide, and the like. In an exemplary embodiment, the CO₂/N₂ separation membrane is a semi-permeable membrane that has a selectivity of at least about 10 of carbon dioxide over nitrogen. As such, carbon dioxide preferentially permeates through the membrane over nitrogen to form a CO₂-rich permeate stream and a N₂-rich retentate stream. The N₂-rich retentate stream may be passed along to form a blanket of nitrogen over liquid hydrocarbons.

In an exemplary embodiment, prior to contacting the CO₂/N₂ separation membrane, the flue gas stream is directed from the flue gas source to a first water removal zone. The first water removal zone removes water from the flue gas stream to form a partially water-depleted flue gas stream. In one example, a majority of the water is removed from the flue gas stream such that the partially water-depleted flue gas stream comprises about 85% or greater by volume of nitrogen. A compressor receives and compresses the partially water-depleted flue gas stream to form a compressed flue gas stream. In fluid communication with the compressor is a second water removal zone that receives the compressed flue gas stream. The second water removal zone removes water from the compressed flue gas stream to form a compressed water-depleted flue gas stream. The compressed water-depleted flue gas stream is directed to the CO₂/N₂ separation membrane to form the N₂-rich retentate stream. Because the CO₂/N₂ separation membrane has a relatively high selectivity of at least about 10 of carbon dioxide over nitrogen and further, because the volume percentage of nitrogen in the partially water-depleted flue gas stream is relatively high, smaller volumes of compressed gas are needed for contact with the separation membrane to generate the equivalent amounts of nitrogen compared to conventional processes. Moreover, it has been found that by contacting the CO₂/N₂ separation membrane with the compressed flue gas stream that is substantially depleted of water, condensation of water on the separation membrane is minimized or eliminated to help maintain and/or prolong functionality of the separation membrane. As such, the capital expenses for compressors and/or the associated operational costs for generating nitrogen including any replacement cost for separation membranes may be less.

Referring to the Figure, an apparatus 10 for generating nitrogen in accordance with an exemplary embodiment is provided. The apparatus 10 may be located on a floating vessel of an offshore operation, such as in a FPSO or FLNG application, or otherwise. Alternatively, the apparatus 10 may be located onshore as part of an onshore operation. The apparatus 10 comprises a flue gas source 12, a water removal zone 14, a compressor 16, a water removal zone 18, a membrane-separation zone 20, and a liquid hydrocarbon storage zone 22. As used herein, the term “zone” can refer to an area including one or more equipment items and/or one or more sub-zones. Equipment items can include one or more vessels, heaters, exchangers, coolers, pipes, pumps, controllers, and the like.

The flue gas source 12 combusts hydrocarbons in the presence of oxygen, e.g., air, to form a flue gas stream 24. The flue gas source 12 may be a power plant, e.g., small power plant on board a floating vessel, a steam generator, or any other utility section or system for combusting hydrocarbons to form a flue gas that contains nitrogen. In one example, the flue gas stream 24 comprises about 75 to about 80% by volume of nitrogen, about 7 to about 8% by volume of carbon dioxide, about 15% or greater by volume of water, and a remainder of other gases including oxygen, carbon monoxide, and the like. In one embodiment, the flue gas stream 24 has a temperature of about 150° C. or greater, such as from about 150 to about 500° C.

In an exemplary embodiment, the flue gas stream 24 is passed along and introduced to the water removal zone 14. The water removal zone 14 removes water from the flue gas stream 24 to form a partially water-depleted flue gas stream 26. In an exemplary embodiment, the water removal zone 14 cools, e.g., via an air cooler, water cooler, exchanger or the like, the flue gas stream 24 to remove water and form a partially water-depleted flue gas stream 26. In one embodiment, the water removal zone 14 cools the flue gas stream 24 to a temperature of from about 20 to about 50° C. As discussed above, removing water from the flue gas stream 24 effectively increases the nitrogen volumetric content in the flue gas. In one example, the partially water-depleted flue gas stream 26 comprises 85% by volume or greater of nitrogen. As illustrated, water is removed from the water removal zone 14 as stream 28.

In an exemplary embodiment, the partially water-depleted flue gas stream 26 flows to the compressor 16. The compressor 16 compresses the partially water-depleted flue gas stream 26 to form a compressed flue gas stream 30. In one embodiment, the compressor 16 forms the compressed flue gas stream 30 having a pressure of at least about 670 kPa gauge, for example from about 670 to about 1380 kPa gauge. In another embodiment, the compressed flue gas stream 30 is formed having a temperature of from about 100 to about 200° C., for example from about 125 to about 175° C.

In an exemplary embodiment, the compressed flue gas stream 30 is passed along and introduced to the water removal zone 18. The water removal zone 18 removes water from the compressed flue gas stream 30 to form a compressed water-depleted flue gas stream 32. In an exemplary embodiment, the water removal zone 18 cools, e.g., via an air cooler, water cooler, exchanger or the like, the compressed flue gas stream 30 to remove water and form the compressed water-depleted flue gas stream 32. In one embodiment, the water removal zone 18 cools the compressed flue gas stream 30 to a temperature of from about 20 to about 50° C. As illustrated, water is removed from the water removal zone 18 as stream 34. In an embodiment, the compressed water-depleted flue gas stream 32 has about 87% by volume of nitrogen or greater.

The compressed water-depleted flue gas stream 32 flows to the membrane-separation zone 20. The membrane-separation zone 20 comprises a CO₂/N₂ separation membrane 36. In one embodiment, the CO₂/N₂ separation membrane 36 is a polymeric membrane. The polymeric membrane comprises a polymer selected from the group consisting of polysulfone, polyethersulfone, polyamide, polyimide, aromatic polyimide, polyamide-imide, polyetherimide, polybenzoxazole, cellulose nitrate, cellulose acetate, cellulose triacetate, polyurethane, polycarbonate, polystyrene, polymer with the intrinsic microporosity, and mixtures or blends thereof In another embodiment, the CO₂/N₂ separation membrane 36 is an inorganic membrane. The inorganic membrane comprises an inorganic membrane material selected from the group consisting of zeolite, molecular sieve, sol-gel silica, metal organic framework, carbon molecular sieve, and mixtures thereof Alternatively, the CO₂/N₂ separation membrane 36 can be any other separation membrane known to those skilled in the art for separating nitrogen and carbon dioxide. In an exemplary embodiment, the CO₂/N₂ separation membrane 36 has a selectivity of at least about 10, preferably at least about 15, for example from about 20 to about 50 or greater, of carbon dioxide over nitrogen.

As illustrated, the membrane-separation zone 20 has a retentate side 38 of the CO₂/N₂ separation membrane 36 and a permeate side 40 of the CO₂/N₂ separation membrane 36. The compressed water-depleted flue gas stream 32 contacts the CO₂/N₂ separation membrane 36 and carbon dioxide preferentially permeates through the membrane 36 over nitrogen to form a N₂-rich retentate stream 42 that collects on the retentate side 38 and a CO₂-rich permeate stream that collects on the permeate side 40.

In one embodiment, the compressed water-depleted flue gas stream 32 may contain some residual moisture and have a corresponding dewpoint temperature. The membrane-separation zone 20 is configured to heat the compressed water-depleted flue gas stream 32 to a temperature of at least about 10° C. greater, such as about 10 to about 50° C. greater, than the dewpoint temperature of the compressed water-depleted flue gas stream 32 prior to contact with the CO₂/N₂ separation membrane 36. In one embodiment, the membrane-separation zone 20 heats the compressed water-depleted flue gas stream 32 to a temperature of at least about 50° C., for example from about 50 to about 200° C. As discussed above, heating the compressed water-depleted flue gas stream 32 so that water does not condense on the CO₂/N₂ separation membrane 36 has been found to help maintain and/or prolong the semi-permeable functionality of the CO₂/N₂ separation membrane 36.

In an exemplary embodiment, the N₂-rich retentate stream 42 is passed along and introduced to the liquid hydrocarbon storage zone 22. As illustrated, the liquid hydrocarbon storage zone 22 contains liquid hydrocarbons 46. The N₂-rich retentate stream 42 flows over to cover the liquid hydrocarbons 46 and form a blanket 48 of nitrogen.

Accordingly, methods and apparatuses for generating nitrogen have been described. Unlike the prior art, the embodiments taught herein contact at least a portion of a flue gas stream, which may be compressed or pressurized and substantially depleted of water, with a CO₂/N₂ separation membrane. Carbon dioxide preferentially permeates through the CO₂/N₂ separation membrane over nitrogen to form a CO₂-rich permeate stream and a N₂-rich retentate stream. The N₂-rich retentate stream may be passed along to form a blanket of nitrogen over liquid hydrocarbons.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A method for generating nitrogen, the method comprising the steps of:
contacting at least a portion of a flue gas stream with a CO₂/N₂ separation membrane at conditions effective to form a N₂-rich retentate stream and a CO₂-rich permeate stream; and
covering liquid hydrocarbons with the N₂-rich retentate stream to form a blanket of nitrogen.

2. The method of claim 1, wherein the step of contacting includes contacting the at least the portion of the flue gas stream with the CO₂/N₂ separation membrane that has a selectivity of at least about 10 of carbon dioxide over nitrogen.

3. The method of claim 1, wherein the at least the portion of the flue gas stream has a dewpoint temperature, and wherein the step of contacting includes contacting the at least the portion of the flue gas stream with the CO₂/N₂ separation membrane at a temperature of at least about 10° C. greater than the dewpoint temperature.

4. The method of claim 1, wherein the step of contacting includes contacting the at least the portion of the flue gas stream with the CO₂/N₂ separation membrane at the conditions that include a pressure of at least about 670 kPa gauge.

5. The method of claim 1, wherein the step of contacting includes contacting the at least the portion of the flue gas stream with the CO₂/N₂ separation membrane that comprises a polymer selected from the group consisting of polysulfone, polyethersulfone, polyamide, polyimide, aromatic polyimide, polyamide-imide, polyetherimide, polybenzoxazole, cellulose nitrate, cellulose acetate, cellulose triacetate, polyurethane, polycarbonate, polystyrene, polymer with the intrinsic microporosity, and mixtures or blends thereof

6. The method of claim 1, wherein the step of contacting includes contacting the at least the portion of the flue gas stream with the CO₂/N₂ separation membrane that comprises an inorganic membrane material selected from the group consisting of zeolite, molecular sieve, sol-gel silica, metal organic framework, carbon molecular sieve, and mixtures thereof

7. A method for generating nitrogen, the method comprising the steps of:
removing water from a flue gas stream to form a partially water-depleted flue gas stream:
compressing the partially water-depleted flue gas stream to form a compressed flue gas stream;
removing water from the compressed flue gas stream to form a compressed water-depleted flue gas stream; and
contacting the compressed water-depleted flue gas stream with a CO₂/N₂ separation membrane to form a N₂-rich retentate stream and a CO₂-rich permeate stream.

8. The method of claim 7, wherein the step of removing water from the flue gas stream includes cooling the flue gas stream.

9. The method of claim 8, wherein the step of cooling includes cooling the flue gas stream to a temperature of from about 20 to about 50° C.

10. The method of claim 7, wherein the step of compressing includes compressing the partially water-depleted flue gas stream to a pressure of from about 670 to about 1,380 kPa gauge.

11. The method of claim 7, wherein the step of removing water from the compressed flue gas stream includes cooling the compressed flue gas stream.

12. The method of claim 11, wherein the step of cooling includes cooling the compressed flue gas stream to a temperature of from about 20 to about 50° C.

13. The method of claim 7, wherein the compressed water-depleted flue gas stream has a dewpoint temperature, and wherein the method further comprises the step of:
heating the compressed water-depleted flue gas stream to a temperature of at least about 10° C. greater than the dewpoint temperature prior to the step of contacting.

14. The method of claim 7, further comprising the step of:
covering liquid hydrocarbons with the N₂-rich retentate stream to form a blanket of nitrogen.

15. An apparatus for generating nitrogen, the apparatus comprising:
a flue gas source configured to combust hydrocarbons in the presence of oxygen to form a flue gas stream;
a membrane-separation zone comprising a CO₂/N₂ separation membrane and configured to receive at least a portion of the flue gas stream and to contact the at least the portion of the flue gas stream with the CO₂/N₂ separation membrane at conditions effective to form a N₂-rich retentate stream and a CO₂-rich permeate stream; and
a liquid hydrocarbon storage zone containing liquid hydrocarbons and configured to receive the N₂-rich retentate stream and to cover the liquid hydrocarbons with the N₂-rich retentate stream to form a blanket of nitrogen.

16. The apparatus of claim 15, further comprising:
a first water removal zone configured to receive and remove water from the flue gas stream to form a partially water-depleted flue gas stream;
a compressor configured to receive and compress the partially water-depleted flue gas stream to form a compressed flue gas stream;
a second water removal zone configured to receive and remove water from the compressed flue gas stream to form a compressed water-depleted flue gas stream, and wherein the membrane-separation zone is configured to receive the compressed water-depleted flue gas stream to form the N₂-rich retentate stream.

17. The apparatus of claim 16, wherein the first water removal zone is further configured to cool the flue gas stream.

18. The apparatus of claim 16, wherein the second water removal zone is further configured to cool the compressed flue gas stream.

19. The apparatus of claim 16, wherein the membrane-separation zone is configured to heat the compressed water-depleted flue gas stream.
